(19) United States
(12) Patent Application Publication
(10) Pub. No.: US 2010/0308657 A1
(43) Pub. Date: Dec. 9, 2010

(54) Electronic Control Module Activated by Toggling a Wall Switch

(76) Inventor: John C. Bucher, Fort Lauderdale, FL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/478,796

(22) Filed: Jun. 5, 2009

(51) Int. Cl. H01H 9/54

(52) U.S. Cl. 307/41

(57) ABSTRACT

An electronic control module incorporated into an appliance to control the operational states thereof by toggling of a conventional single-pole wall switch that supplies electrical power thereto.

### BACKGROUND OF THE INVENTION

1. Field of the Invention

This invention relates to electrical appliances such as fluorescent and incandescent lighting, ceiling fans and exhaust fans. More particularly, this invention relates to operation of the electrical appliance by toggling a wall switch.

2. Description of the Background Art

Presently, there exist many types of electrical appliances that are controlled by the operation of a wall switch. Representative types of electrical appliances include fluorescent and incandescent lighting, ceiling fans and bathroom and other exhaust fans. These types of electrical appliances may be floor-mounted, table-mounted, wall-mounted or ceiling-mounted. Further, one electrical appliance may be incorporated into another, such as in the case of a ceiling fan having a light kit attached to the lowermost end of the ceiling fan.

These types of electrical appliances are conventionally controlled by a single-pole wall switch, usually conveniently installed in a wall proximate to the location of the specific appliance.

In lieu of single-pole wall switches, specialized multi-pole wall switches have been developed, such as ones for controlling the high, medium and low speeds operational of the ceiling fan. Similarly, specialized dimmer switches have been designed to dim the light output from the light appliance. However, multi-pole wall switches typically require the wiring of multiple conductors between the wall switch and the ceiling fan.

More specifically, wall switches have been employed to control the multiple operational speeds of ceiling fans or to control power to individual lamps of a multi-lamp light appliance.

For example, U.S. Pat. No. 4,766,353 entitled “Lamp Switching Circuit and Method”, the disclosure of which is hereby incorporated by reference herein, discloses a lamp switching circuit and method for selectively energizing one or more lamps of a bank of lamps and then thereafter energizing other of the lamps when power is interrupted and next applied through the use of a four-pole double-throw switch assembly. U.S. Pat. No. 4,879,495 entitled “Illumination Control Methods and Means”, the disclosure of which is hereby incorporated by reference herein, discloses a system and method for altering the amount of electrical energy supplied to a plurality of fluorescent lamps through the use of a pair of switches, each of which controls electrical power to one or more lamps.

U.S. Pat. No. 4,896,079 entitled “Bi-Level Switch”, the disclosure of which is hereby incorporated by reference herein, teaches a control mechanism for use with a fluorescent lighting unit having at least a first and second fluorescent lamp controlled using a light switch that may be toggled to control the operation thereof. Finally, U.S. Pat. No. 5,610,488 entitled “Universal Switching Device and Method for Lighting Applications”, the disclosure of which is hereby incorporated by reference herein, teaches a universal electronic switching device to switch electrical power to one or more loads, either individually or in groups, in a predetermined pattern in response to the toggling of a single-pole wall switch.

Similar to controlling electrical power to multiple fluorescent lamps by toggling a single-pole wall switch, the operational speeds of ceiling fans (e.g., high, medium & low speeds) have likewise been controlled by multiple toggling of a single-pole wall switch. One such type of fan control is currently being marketed under the trademark “Flip-A-Switch” by King of Fans, Inc., the assignee of the present invention.

Presently, there exists a need for an improved electronic control module for controlling electrical power to appliances upon toggling a single-pole wall switch to turn on and off and adjust the electrical power supplied to the appliance upon each throw or toggle of the light switch.

Therefore, it is an object of this invention to provide an improvement which overcomes the aforementioned inadequacies of the prior art devices and provides an improvement which is a significant contribution to the advancement of the electrical appliance art.

Another object of this invention is to provide an electronic module for turning on and off and adjusting the electrical power supplied to an electrical appliance upon toggling a single-pole wall switch.

Another object of this invention is to provide an electronic module for turning on and off and adjusting the electrical power supplied to an electrical appliance upon toggling a single-pole wall switch that is capable for use in conjunction with a variety of electrical appliances such as fluorescent and incandescent lighting, ceiling fans and bathroom and other exhaust fans.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, the invention comprises an electronic control module incorporated into an appliance to control the operational states thereof by toggling of a conventional single-pole wall switch that supplies electrical power thereto.

More particularly, some embodiments of the electronic control module of this invention operate to control, upon toggling of the switch, the electrical power flow to the various conductors of the appliance to thereby control the operational states thereof. In another embodiment, the electronic control module of this invention operates, upon toggling of the switch, to vary the percentage of electrical power flowing to the supply-line conductor of the appliance to thereby control the operational state thereof.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a schematic diagram of the electronic control module of the invention operable for controlling electrical power supplied to a multi-conductor electrical appliance such as am incandescent light appliance having two incandescent lamps;

FIG. 2 is a schematic diagram of the electronic control module of the invention operable for controlling high frequency electrical power supplied to a multi-conductor electrical appliance such as a multi-speed lighted bathroom vent; and

FIG. 3 is a schematic diagram of an oscillator circuit that may be employed in conjunction with the electronic control module of the invention for controlling high frequency electrical current supplied to a fluorescent lighting appliance composed of two fluorescent bulbs;

FIG. 4 is a bottom plan view of a circular fluorescent lighting appliance composed of two fluorescent bulbs; and

FIG. 5 is a schematic diagram of another embodiment of an electronic control module of the invention operable for controlling high frequency electrical power supplied to a multi-conductor electrical appliance such as a fluorescent lighting appliance composed of two fluorescent bulbs.

Similar reference characters refer to similar parts throughout the several views of the drawings.

### DETAILED DESCRIPTION OF THE PREFERRED EMBODIMENTS

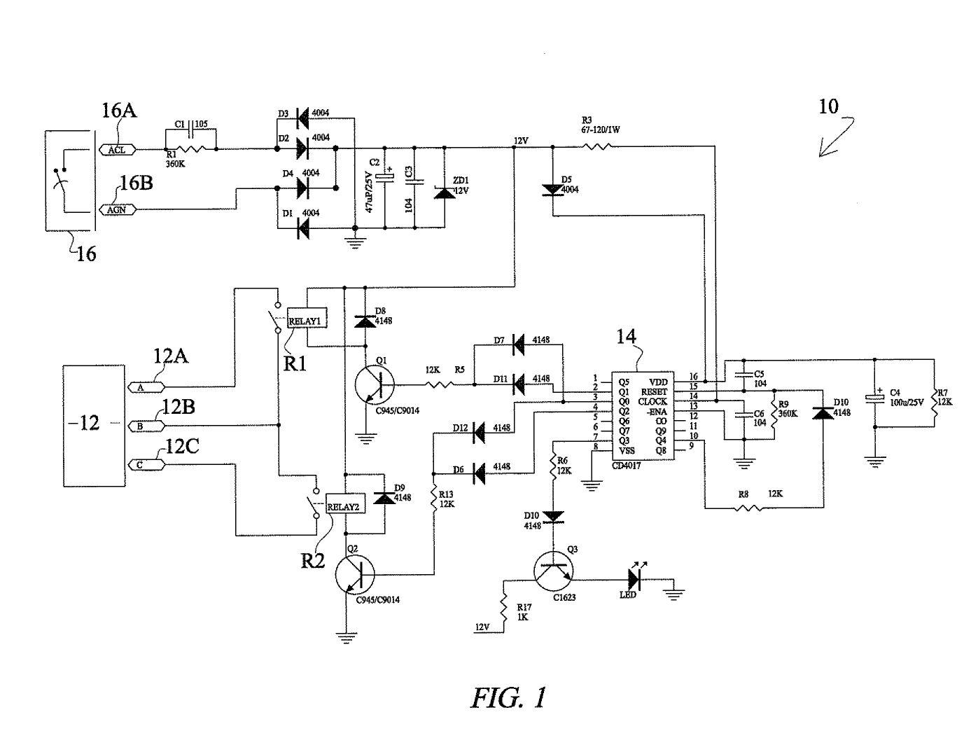

Referring to the schematic of FIG. 1, the electronic control module 10 of the invention is operable for controlling electrical power supplied to a multi-conductor electrical appliance 12 having multiple conductors (e.g., three) 12A, 12B and 12C. For purpose of illustration and not limitation, the electrical appliance 12 may comprise an incandescent light appliance having multiple conductors (e.g., three) 12A, 12B and 12C with conductor 12B configured to be electrically connected to line voltage and the other conductors 12A and 12C configured to be electrically connected to its lamp filaments such that both, or one or the other, filaments are energized to provide high, medium or low light output.

More specifically, the control module 10 comprises a decade counter/divider 14 (e.g., CD4017) operatively connected between a single-pole wall switch 16 having AC line and neutral poles 16A and 16B and the electrical appliance's 12 multiple conductors 12A, 12B and 12C. The input of the module 10 comprises rectifiers D1, D2, D3 and D4 that rectify the AC line voltage when the pole of the wall switch 16 is closed. Zenor diode ZD1 regulates the rectified voltage from the rectifiers D1, D2, D3 and D4 to a constant value (e.g., 12 volts). The resulting pulses produced upon each toggling of the wall switch 16 is supplied to the clock input CLOCK (pin 14) of the decade counter/divider 14.

The outputs Q0-Q7 of the decade counter/divider 14 are connected a driver transistors Q1 and Q2 for activating respective relays R1 and R2. Preferably, output Q0 is connected through blocking diodes D7 and D12 to the bases of respective drive transistors Q1 and Q2 connected to respective relays R1 and R2 whose contacts are respectively connected in series with two of the conductors 12A and 12C and jointly connected to the remaining conductor 12B such that upon the first toggle of the wall switch 16, only output Q0 goes high and all the three conductors 12A, 12B and 12C are electrically connected together. With the conductor 12B connected to line voltage, it is readily seen that upon the first toggle of the wall switch 16 (i.e., when the switch 16 is first closed to “turn-on” the appliance 12), both relays R1 and R2 are closed and line voltage from conductor 12B is supplied to both conductors 12A and 12C.

Also preferably, output Q1 is connected through another blocking diode D11 to the drive transistor Q1. Consequently, upon the second toggle of the wall switch 16 (i.e., upon opening then immediately closing switch 16), only output Q1 goes high, only drive transistor Q1 turns on and only relay R1 closed. Consequently, only conductor 12A is connected to conductor 12B.

Still also preferably, output Q2 is connected through another blocking diode D6 to the drive transistor Q2. Consequently, upon the third toggle of the wall switch 16 (i.e., upon opening then immediately closing switch 16), only output Q2 goes high, only drive transistor Q2 turns on and only relay R2 closed. Consequently, only conductor 12C is connected to conductor 12B.

As noted above, the electrical appliance 12 may comprise an incandescent light appliance having multiple conductors 12A, 12B and 12C with conductor 12B connected to line voltage and the other conductors 12A and 12C connected to its lamp filaments (e.g., medium-output and low-output lamp filaments). Upon the first toggle of the wall switch 16, line voltage is supplied to both filaments to thereby produce a “high” light output. Upon the second toggle, the line voltage is supplied to only the medium-output filament to thereby produce a “medium” light output. Upon the third toggle, the line voltage is supplied to only the low-output filament to produce a “low” light output.

Optionally, output Q3 is connected through another blocking diode D10 to the drive transistor Q3 that when closed, supplies the 12 volt voltage to an LED1 (or a plurality of LEDs). Consequently, upon the fourth toggle of the wall switch 16 (i.e., upon opening then immediately closing switch 16), only output Q3 goes high, only drive transistor Q3 turns on and only LED1 is energized to provide “night light” illumination.

Finally, output Q4 is connected through another blocking diode D10 to the reset input of the decade counter/divider 14. Consequently, upon the fifth toggle of the wall switch 16 (i.e., upon opening then immediately closing switch 16), only output Q4 goes high, and the decade counter/divider 14 is reset, allowing the toggling sequence to be restarted.

It is noted that power to the decade counter/divider 14 from the rectifiers D1, D2, D3 and D4 and zenor diode ZD1 is momentarily interrupted each time the pole of the wall switch 16 is opened after being closed (i.e., upon each toggling). However, capacitor C4 is charged during closure of the switch 16 and provides power to decade counter/divider 14 to power the same while the switch 16 is toggled open.

The toggling sequence of the electronic control module 10 is automatically “reset” via reset input after a predetermined delay determined by capacitor C5 and resistor R9 (e.g., 3 seconds). The automatic resetting of the electronic control module 10 after the delay assures that the toggling sequence will always restart at the beginning instead of requiring the toggling sequence to be stepped all the way through from where it last left off. For example, suppose the appliance 12 had been on the “medium” light output (the second toggle) and has now been turned off longer than the delay period. Upon the next closure of the switch 12, the toggling sequence, having been reset, restarts at the first toggle instead of resuming at the third toggle.

As noted in connection with FIG. 1, the electronic control module 10 of the invention is operable for controlling electrical power supplied to a multi-conductor electrical appliance 12 having multiple conductors (e.g., three) 12A, 12B and 12C such as an incandescent light appliance 12. For example, instead of an incandescent light appliance 12, appliance 12 may comprise a single-speed lighted bathroom vent 12 in which the conductors 12A and 12C are connected to the conductor for the light and the conductor for the vent motor, respectively, to turn on the light and vent, to turn on only the light, and to turn on only the vent upon successive toggling of the switch 16.

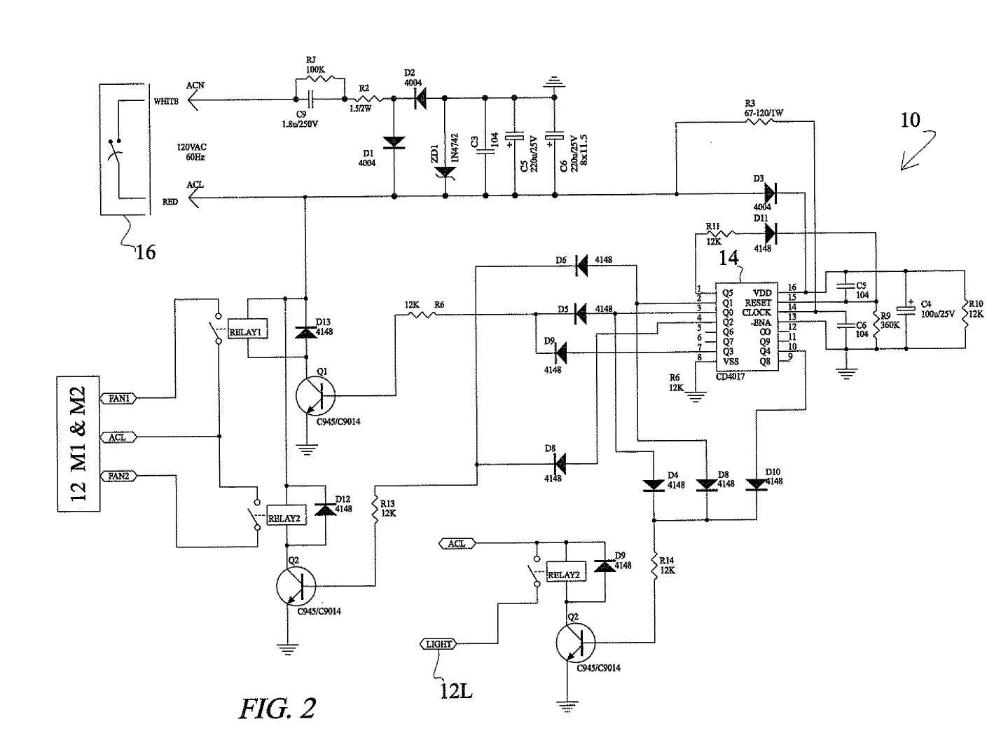

As shown in FIG. 2, the electronic control module 10 may be employed to operate a two-speed lighted bathroom vent having multiple conductors (e.g., three) 12A, 12B and 12C with conductor 12B configured to be electrically connected to line voltage and the other conductors 12A and 12C configured to be electrically connected to its windings M1 & M2 of its vent fan motor 12M.

The electronic control module 10 of FIG. 2 is substantially the same as FIG. 1, with the addition of a third relay R3 driven by capacitor Q3 controlled by outputs Q0, Q1 & Q4 of the decade counter/divider 14 to power the light 12L of lighted bathroom vent appliance 12 (in lieu of the night-light feature of the lighted appliance 12 of FIG. 1). More specifically, toggling of the switch 16 causes the decade counter/divider 14 to step through its outputs Q0-Q4 as follows:

| Toggle | Relay | Action |
|---|---|---|
| 1 (Q0) | R1 & R3 closed | Fan on high, light on |
| 2 (Q1) | R2 & R3 closed | Fan on low, light on |
| 3 (Q2) | R2 closed | Fan on low, light off |
| 4 (Q3) | R1 closed | Fan on high, light off |
| 5 (Q4) | R3 closed | Fan off, light on |

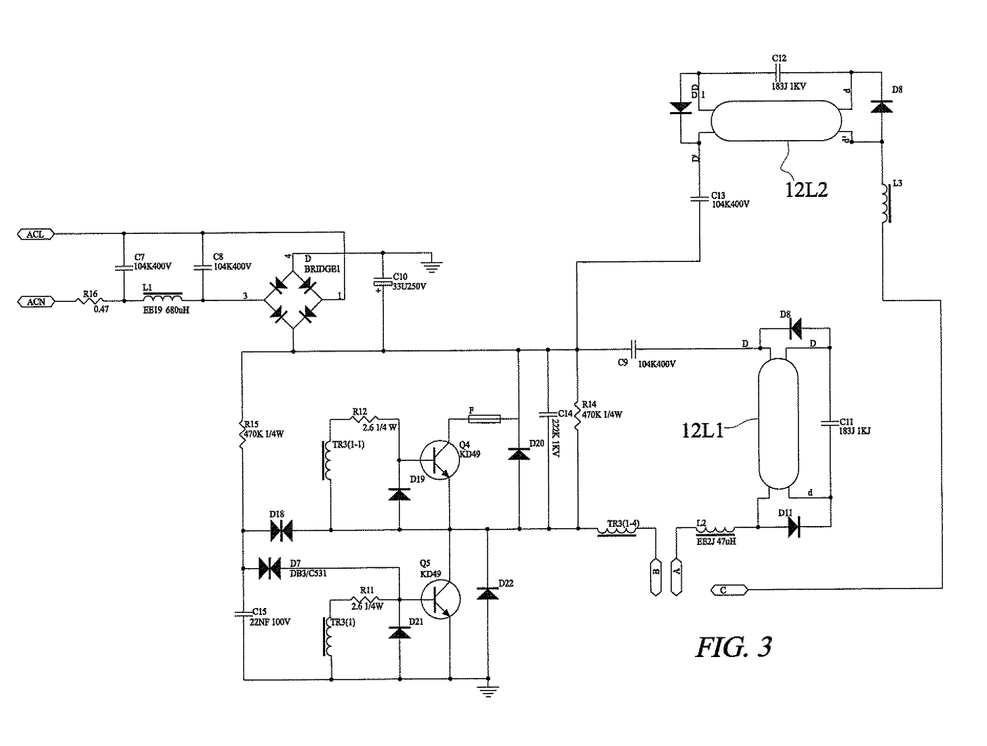

In lieu of an incandescent light appliance, the electronic control module 10 may alternatively be employed to power a fluorescent light appliance 12 by connecting its terminals 12A, 12B and 12C to an oscillator circuit 20, such as that shown in FIG. 3, that provides a high frequency current to a pair of fluorescent lamps 12L1 & 12L2 to cause illumination of either or both lamps 12L1 & 12L2. Preferably, lamp 12L1 provides a higher light output than lamp 12L2 such that the highest light output is achieved when both lamps 12L1 & 12L2 are on, a medium light output is achieved when lamp 12L1 is on (lamp 12L2 off) and a low light output is achieved when lamp 12K2 is on (lamp 12L1 off).

As shown in FIG. 3, one embodiment of the oscillator circuit 20 may comprise supplying rectified supply power from AC line voltage via bridge rectifier B1 (with capacitor C10 providing power during toggling) to an oscillator that produces a square wave output (shaped to a sinusoidal) to the respective fluorescent lamps 12L1 & 12L2. Consequently, as in the embodiment of the incandescent light appliance of FIG. 1, the fluorescent light appliance embodiment of FIG. 3 operates as follows:

| Toggle | Relay | Action |
|---|---|---|
| 1 (Q0) | R1 and R2 closed | Both lamps 12L1 and 12L2 on |
| 2 (Q1) | R2 closed | Lamp 12L1 on, 12L2 off |
| 3 (Q2) | R3 closed | Lamp 12L1 off, 12L2 on |

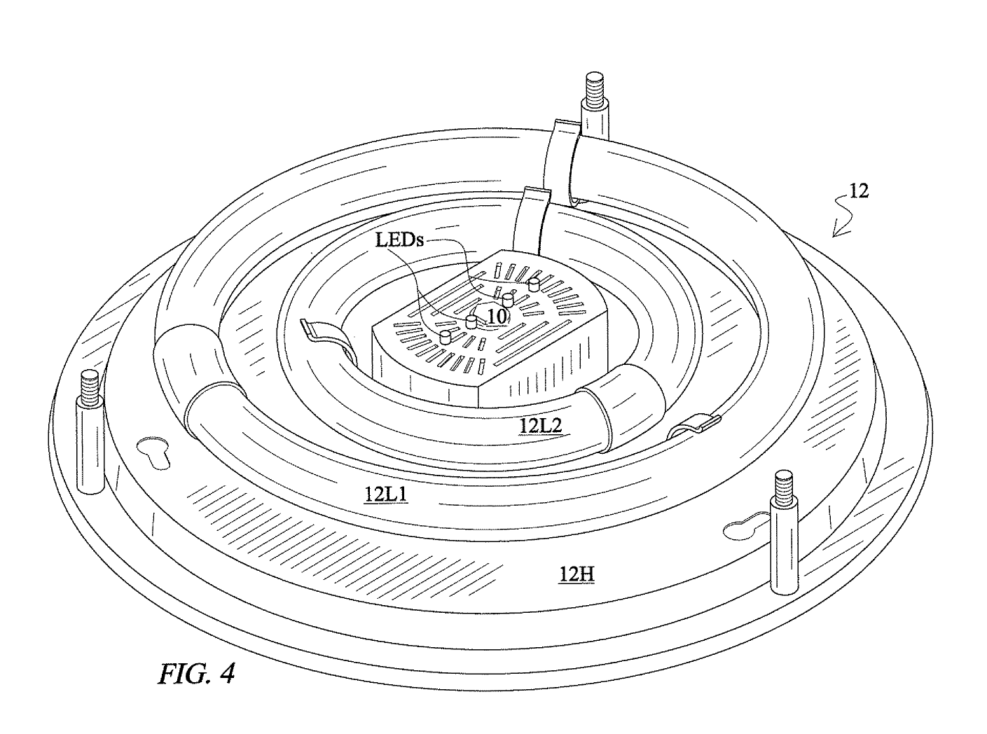

As noted above, lamp 12L1 preferably provides a higher light output than lamp 12L2. As shown in FIG. 4, a preferred embodiment of the fluorescent light appliance 12 comprising a housing 12H with the pair of fluorescent lamps lamp 12L1 and 12L2 are operatively connected to the underside of the housing 12H. Preferably, the fluorescent lamps 12L1 and 12L2 each comprise a circular tubular fluorescent lamp, the higher wattage fluorescent lamp 12L1 having a larger diameter and the lower wattage fluorescent lamp 12L2 (e.g., 22 watts) having a smaller diameter such that the lamp 12L2 (e.g., 32 watts) is concentrically nested within the lamp 12L1.

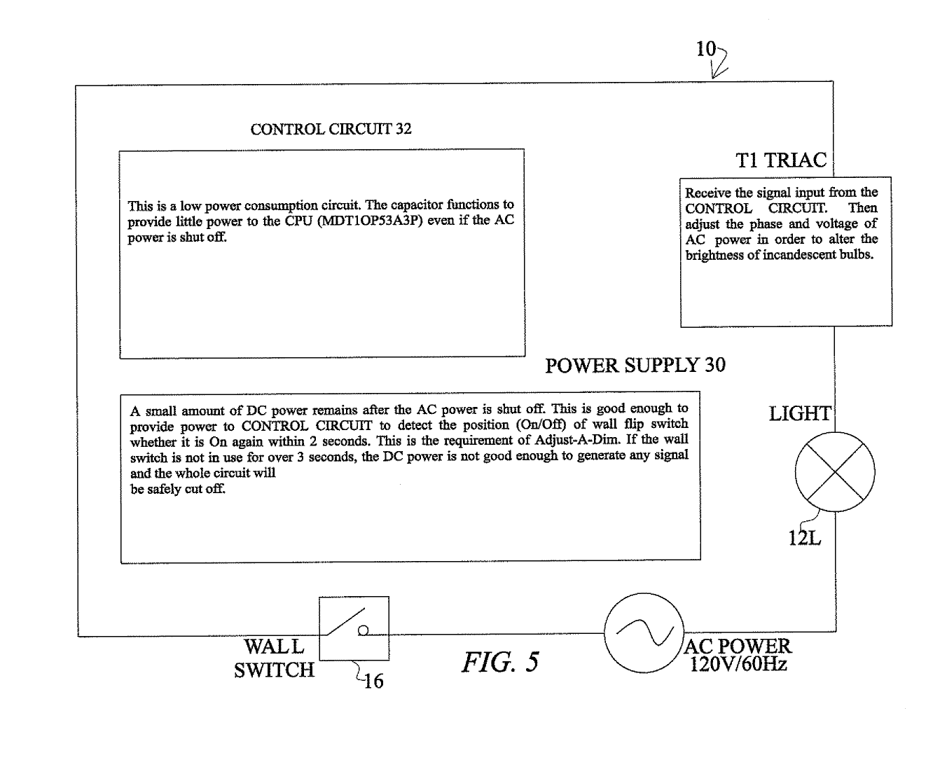

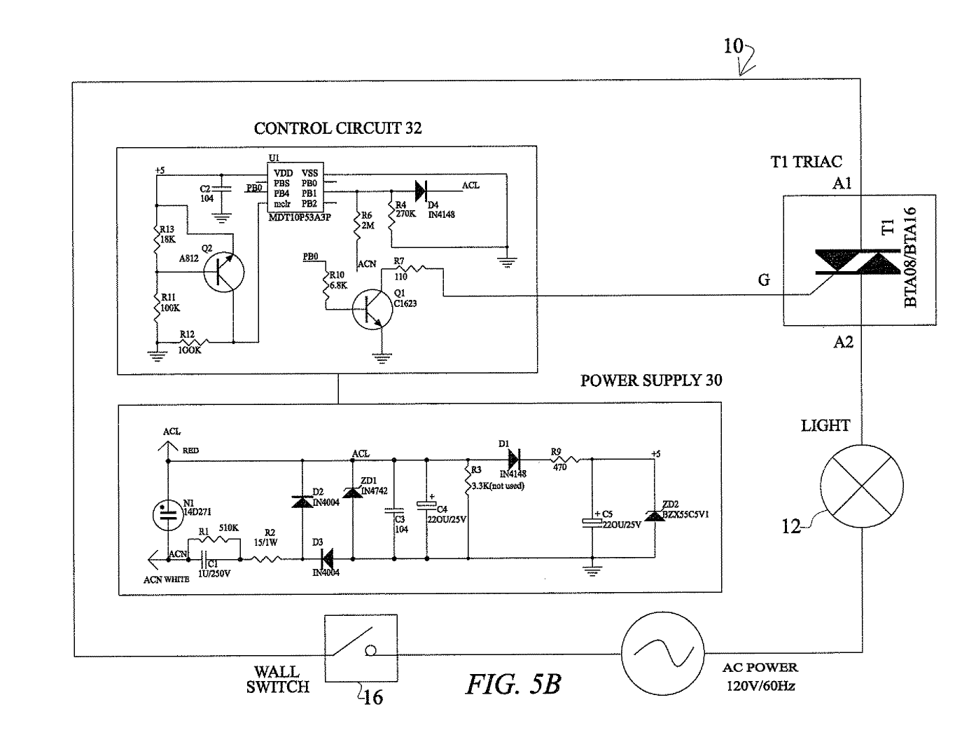

The electronic control module 10 of the invention of FIG. 1 or 2 controls, upon toggling of the switch 16, electrical power supplied to an incandescent lighting appliance composed of two incandescent bulbs. An alternative embodiment employing a triac in lieu of relays, is shown in FIG. 5 (FIG. 5A being an operational block diagram and FIG. 5B being a schematic diagram).

More specifically, referring now to FIGS. 5A and 5B, the electronic control module 10 comprises a power supply 30 that provides sufficient power during toggling to power a low-power-consumption control circuit 32 only for a limited period of time sufficient to allow forthcoming toggling (e.g., 2 seconds) but thereafter provides insufficient power after a predetermined delay (e.g., 3 seconds), thereby functionally resetting the control circuit 32 after the predetermined delay period.

The control circuit 32 comprises a microprocessor U1 (e.g., MDT10P53A3P), that includes firmware that counts the pulses of AC line voltage upon toggling of switch 16 and provides an analog output by means of output transistor Q1 connected to the gate electrode G of a triac T1 (or other device such as a functionally-equivalent of paired silicon-controlled rectifiers) whose anodes A1 and A2 are connected in series with the power line voltage, the incandescent lamp L1 and the switch 16. In this manner, the microprocessor U1 provides an increasing amount of electrical power to the incandescent lamp 12L such that more electrical power is supplied to the incandescent lamp 12L upon each toggle of the switch 16 up to the maximum number of toggles as the microprocessor U1 may have been so programmed. For example, microprocessor U1 may be programmed to count four toggles to provide the following levels of line voltage to the incandescent lamp 12L to achieve the following different levels of light output:

| | Percent of Line | |
|---|---|---|
| Toggle | Voltage | Light Output |
| 1 | 100% | High |
| 2 | 70% | Medium |
| 3 | 50% | Low |
| 4 | 25% | Night Light |

It should be appreciated that the electronic control module 10 may be employed in a large variety of appliances to be controlled by toggling a single-pole wall switch. For example, in addition the appliances described above, electronic control modules 10 may be incorporated within a lighted ceiling fan to control the operational speeds of the ceiling fan and the light output of its light kit by toggling respective single-pole wall switches. The light kit of the ceiling fan may comprise the two generally circular fluorescent lamps 12L1 and 12L2 of different diameters that are concentrically nested together in a single plane with the control module 10 centered therein, thereby achieving a highly compact and attractive design.

During operation, with the light output of the fluorescent lamps being different—the smaller-diameter lamp 12L2 providing lower light output than the larger-diameter lamp 12L1, such as 22 watts versus 32 watts, upon a first toggle of the switch 16 to turn it on, the electronic control module 10 functions to provide electrical power to both lamps 12L1 and 12L2, thereby providing a total lamp output of 54 watts (22 watts plus 32 watts) representing a “high” setting. Upon the second toggling of the wall switch 16 (i.e., flipping it off and then on), the electronic control module 10 supplies electrical power to only the outer fluorescent lamp 12L1, thereby resulting in a light output of 32 watts (i.e., a “medium” setting). Upon a third toggling of the wall switch 16 (i.e., flipping it off and then on again), the electronic control module 10 supplies electrical power to the inner lamp 12L2, thereby providing a light output of 22 watts (i.e., a “low” setting). When the wall switch 16 is turned off, the light appliance is turned “off”.

The predetermined delay built into the electronic control module resets after the wall switch is turned off for a predetermined period of time (e.g., three seconds). Upon being reset, the electronic control module 10 returns to its initial state, such that both lamps are turned on when the wall switch is next toggled (turned on).

In another embodiment of the invention, the lamp appliance may comprise one or more light emitting diodes (LEDs) and the electronic control module 10 may include an additional state that controls the flow of electrical power thereto upon a fourth toggling of the wall switch. The LEDs function to provide a “night light” feature.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. An electronic control module for controlling voltage supplied to at least two conductors of an appliance, comprising a counter electrically connected to a switch for counting the number of toggles of the switch, the counter including at least two outputs electrically connected to the respective two conductors of the appliance for supplying electrical power to one or the other or both of the conductors based upon the number of times the switch is toggled.

2. The electronic control module as set forth in claim 1, wherein, upon a first toggle of the switch, voltage is supplied to both of the conductors, upon a second toggle of the switch, voltage is supplied to only one of the conductors and, upon a third toggle of the switch, voltage is supplied to the other conductor.

3. The electronic control module as set forth in claim 2, wherein the voltage comprises line voltage and further including respective relays whose contacts are connected between the line voltage and the respective conductors and are closed to supply line voltage to the respective conductors upon toggling of the switch.

4. The electronic control module as set forth in claim 3, further including a charged device that provides electrical power to the counter during toggling of the switch.

5. The electronic control module as set forth in claim 4, further including a reset that resets the counter after a predetermined delay to assure that subsequent toggling restarts.

6. The electronic control module as set forth in claim 1 employed in an incandescent light appliance.

7. The electronic control module as set forth in claim 1 employed in a fluorescent light appliance.

8. The electronic control module as set forth in claim 7, further including an oscillator for supplying high frequency current to the conductors.

9. The electronic control module as set forth in claim 1 employed in a lighted vent or fan.

10. The electronic control module as set forth in claim 9, wherein the lighted vent or fan is multi-speed.

11. An electronic control module for controlling electrical power supplied to a conductor of an appliance, comprising a counter electrically connected to a switch for counting the number of toggles of the switch and varying the amount of electrical power supplied to the conductor based upon the number of times the switch is toggled.

12. The electronic control module as set forth in claim 11, wherein, upon a first toggle of the switch, one level of electrical power is supplied to the conductor, upon a second toggle of the switch, another level of electrical power is supplied to the conductor and, upon a third toggle of the switch, still another level of electrical power is supplied to the conductor.

13. The electronic control module as set forth in claim 12, wherein the electrical power comprises high frequency electrical current whose frequency is varied based upon the number of times the switch is toggled.

14. The electronic control module as set forth in claim 13, further including a charged device that provides electrical power to the counter during toggling of the switch.

15. The electronic control module as set forth in claim 14, further including a reset that resets the counter after a predetermined delay to assure that subsequent toggling restarts.

16. The electronic control module as set forth in claim 1 employed in an incandescent light appliance.

17. The electronic control module as set forth in claim 1 employed in a fluorescent light appliance.

18. The electronic control module as set forth in claim 17, further including an oscillator for supplying high frequency current to the conductors.

19. The electronic control module as set forth in claim 1 employed in a lighted vent or fan.

20. The electronic control module as set forth in claim 18, wherein the lighted vent or fan is multi-speed.

21. A lighting appliance, comprising in combination:
a housing;
a first lamp and a second lamp mounted within said housing, said first lamp producing, when electrical power is supplied thereto, a lower light output than the light output produced by the second lamp when electrical power is supplied thereto;
a light control module electrically connected to said first lamp and to said second lamp and to be electrically connected to a first single-pole wall switch that supplies electrical power to said light control module when the first single-pole wall switch is turned on, wherein said light control module supplies the electrical power to both said lamps when the first single-pole wall switch is toggled a first time, supplies electrical power to only said second lamp when the first single-pole wall switch is toggled a second time and supplies electrical power to only said first lamp when the first single-pole wall switch is toggled a third time.

22. The lighting appliance as set forth in claim 21, further including at least one light emitting diode and wherein said light control module is electrically connected to said diode and supplies the electrical power to only said diode when the first single-pole wall switch is toggled a fourth time.

23. The lighting appliance as set forth in claim 21, wherein said light control module comprises a reset timer to reset to its initial state after the expiration of a predetermined time to thereby distinguish between an initial toggling of the first single-pole wall switch and a repeated toggling of the first single-pole wall switch.

24. The lighting appliance as set forth in claim 21, further including a ceiling fan and wherein said lighting appliance is mounted to said ceiling fan, said ceiling fan including a fan control module electrically connected to a motor of said ceiling fan and to be connected to a second single-pole wall switch.

25. The lighting appliance as set forth in claim 24, wherein said fan control module supplies full electrical power to said motor when the second single-pole wall switch is toggled a first time, supplies the reduced electrical power to said motor when the second single-pole wall switch is toggled a second time and supplies further reduced electrical power to said motor when the second single-pole wall switch is toggled a third time.

26. The lighting appliance as set forth in claim 25, wherein said light control module comprises a reset timer to reset to its initial state after the expiration of a predetermined time to thereby distinguish between an initial toggling of the first single-pole wall switch and a repeated toggling of the first single-pole wall switch.
